(19) United States
(12) Patent Application Publication
(10) Pub. No.: US 2014/0182208 A1
(43) Pub. Date: Jul. 3, 2014

(54) AUTOMATIC VENDING MACHINE

(71) Applicants: HON HAI PRECISION INDUSTRY CO., LTD., NEW TAIPEI (TW); HONG FU JIN PRECISION INDUSTRY (WUHAN) CO., LTD., WUHAN (CN)

(72) Inventors: YUN-LUNG CHEN, New Taipei (TW); DA-LONG SUN, Wuhan (CN); LI TONG, Wuhan (CN); HAI-TAO SHAN, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/020,960

(22) Filed: Sep. 9, 2013

(30) Foreign Application Priority Data
Dec. 27, 2012 (CN) 2012105774940

(51) Int. Cl. G07F 9/10; E06B 5/00; E06B 7/16

(52) U.S. Cl. CPC G07F 9/105; E06B 7/16; E06B 5/00
USPC 49/67; 49/475.1

(57) ABSTRACT

An automatic vending machine includes a front door, a thermal insulation door, and a latching member. The thermal insulation door is rotatably secured to the front door. The latching member is secured to the thermal insulation door and engages with the front door to prevent the thermal insulation door from rotating relative to the front door, so that the thermal insulation door is secured to the front door without screws.

### BACKGROUND

1. Technical Field

The present disclosure relates to automatic vending machines, and particularly to an automatic vending machine having a thermal insulation door.

2. Description of Related Art

Automatic vending machines include a front door and a thermal insulation door secured to the front door. The thermal insulation door is used to maintain a predetermined temperature in the vending machine. The thermal insulation door of vending machines is secured to the front door by screws. However, assembly and disassembly of the thermal insulation door is very time-consuming and inconvenient. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembled view of an automatic vending machine in an open position, in accordance with an embodiment.

FIG. 2 is an enlarged view of a circled portion II of FIG. 1.

FIG. 3 is an isometric view of a latching member of FIG. 1.

FIG. 4 is an assembled view of the automatic vending machine of FIG. 1 in a closed position.

FIG. 5 is an enlarged view of a circled portion V of FIG. 4.

FIG. 6 is a cross-sectional view of the automatic vending machine of FIG. 4 taken along line VI-VI.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

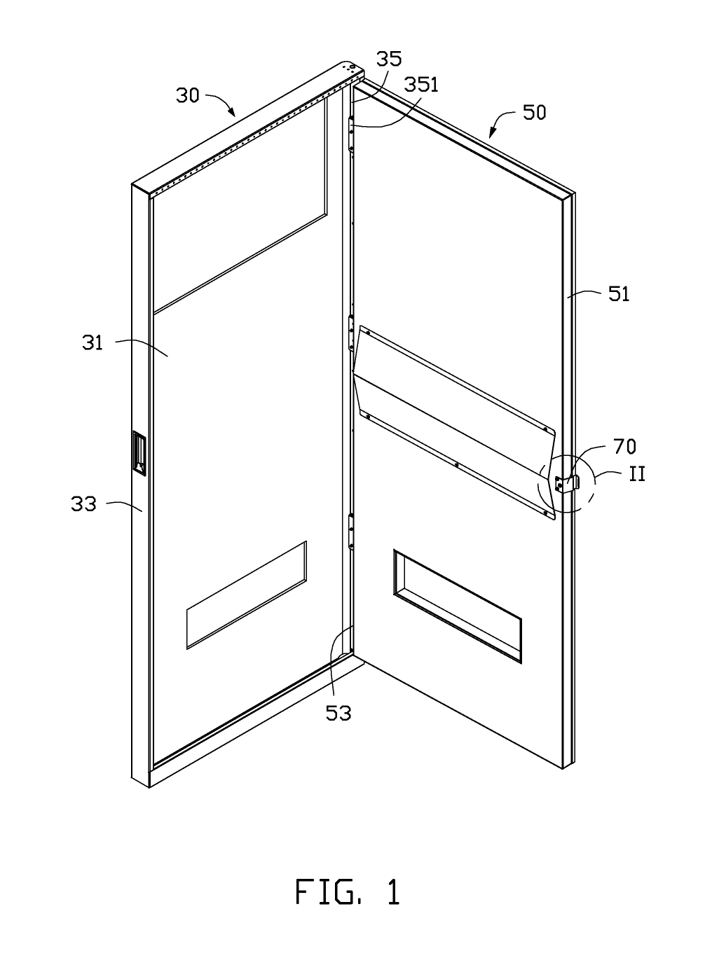

Referring to FIG. 1, an automatic vending machine includes a front door 30, a thermal insulation door 50, and a latching member 70.

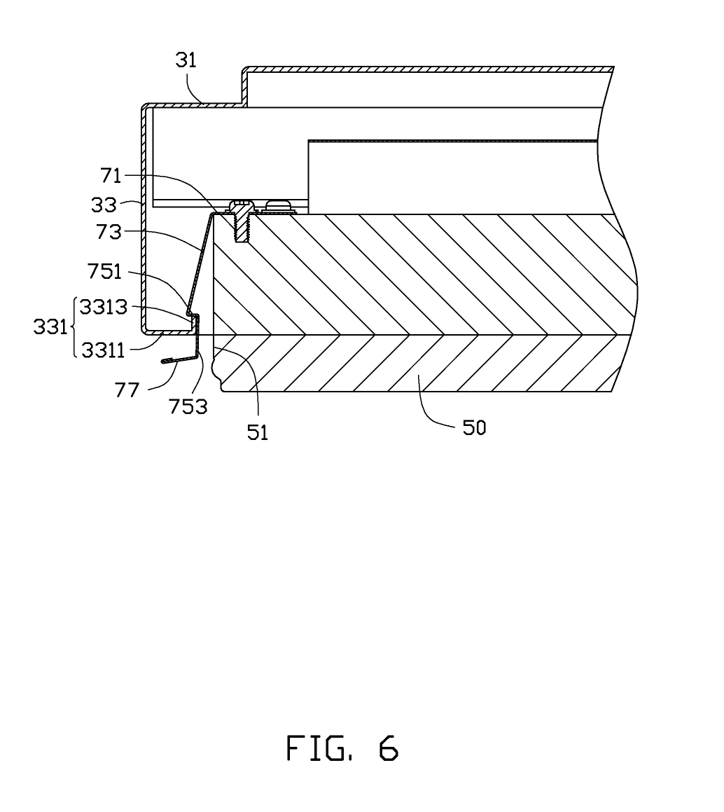

In this embodiment, the front door 30 includes a front plate 31, a first side plate 33, and a second side plate 35. The first side plate 33 and the second side plate 35 are located at opposite sides of the front plate 31. The first side plate 33 and the second side plate 35 are substantially parallel to each other and substantially perpendicular to the front plate 31. A blocking portion 331 (shown in FIG. 6) is located on the first side plate 33. The blocking portion 331 includes a resisting piece 3311 extending from the first side plate 33, and a blocking piece 3313 extending from the resisting piece 3311. The resisting piece 3311 is substantially perpendicular to the first side plate 33, and the blocking piece 3313 is substantially perpendicular to the resisting piece 3311 and parallel to the first side plate 33. Three hinges 351 are located on the second side plate 35, to secure the thermal insulation door 50.

The thermal insulation door 50 has a substantially rectangular cross-section and includes a first sidewall 51 and a second sidewall 53 opposite to the first sidewall 51. A width of the thermal insulation door 50 is slightly smaller than a distance between the first side plate 33 and the second side plate 35.

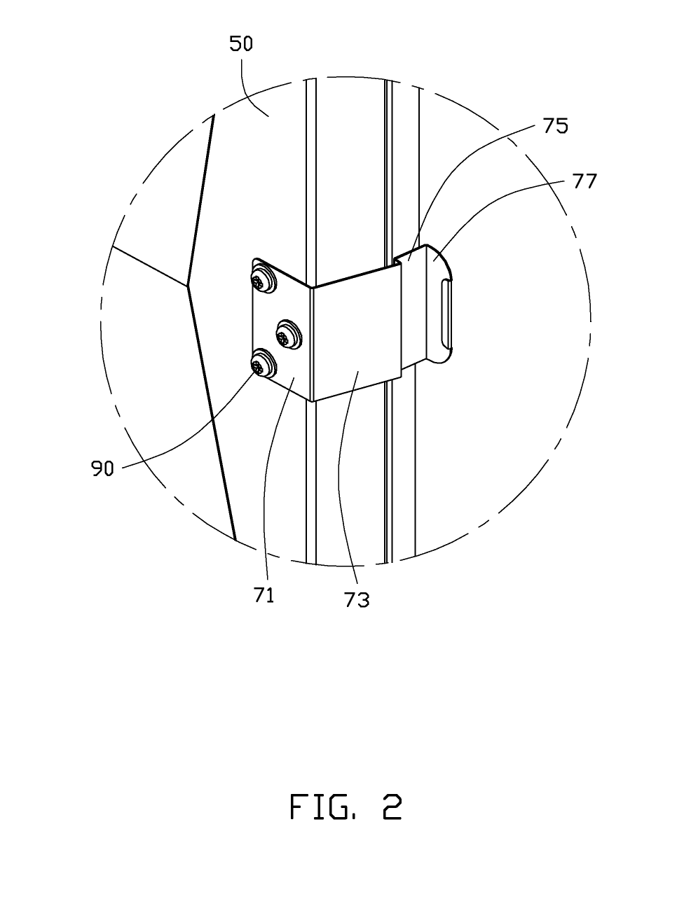

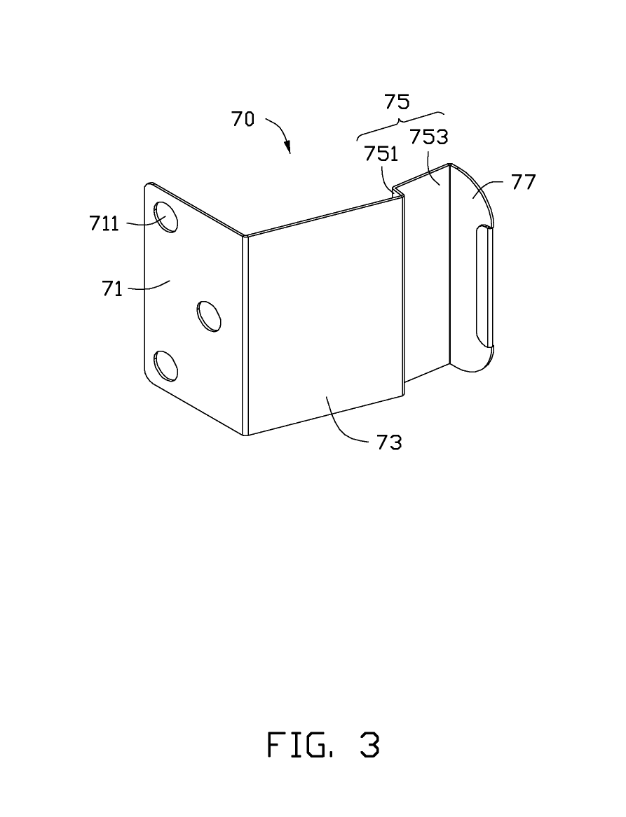

FIGS. 2-3 show that the latching member 70 includes a securing piece 71, a resilient piece 73, a latching portion 75, and an actuating piece 77. In this embodiment, the securing piece 71 is secured to the thermal insulation door 50 by screws. The resilient piece 73 extends from the securing piece 71. An obtuse angle is formed between the securing piece 71 and the resilient piece 73. The latching portion 75 includes a latching piece 751 and a limiting piece 753. The latching piece 751 extends from the resilient piece 73. An acute angle is formed between the latching piece 751 and the resilient piece 73, and the latching piece 751 is substantially parallel to the securing piece 71. The limiting piece 753 extends from the latching piece 751. The limiting piece 753 is perpendicular to the latching piece 751 and the securing piece 71, and an acute angle is defined between the limiting piece 753 and the resilient piece 73. The actuating piece 77 extends from the limiting piece 753. The resilient piece 73 and the limiting piece 753 are arranged at opposite sides of the latching piece 751. The latching piece 751 and the actuating piece 77 are arranged at opposite ends of the limiting piece 753.

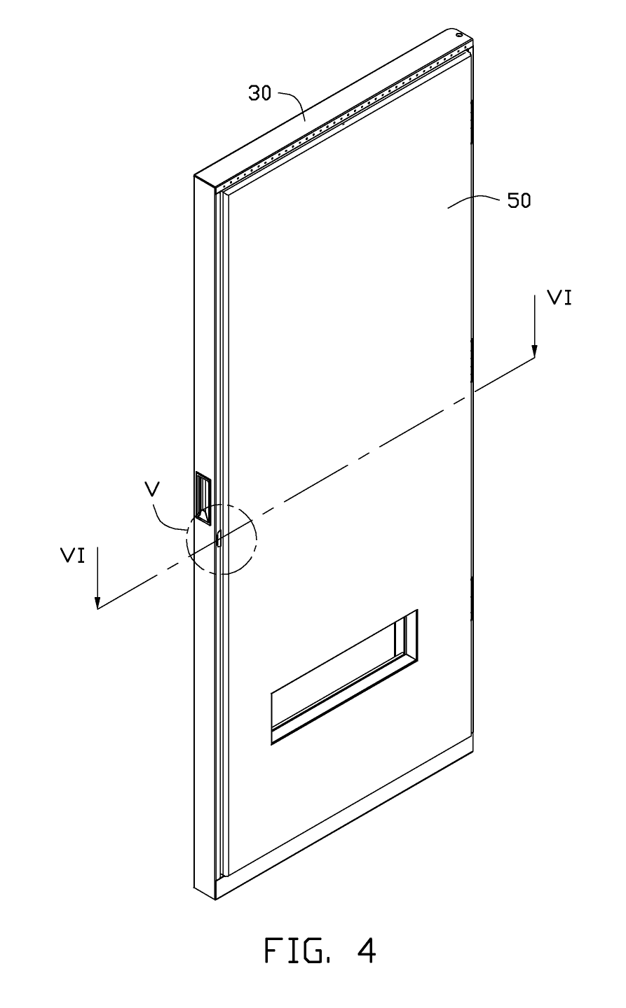

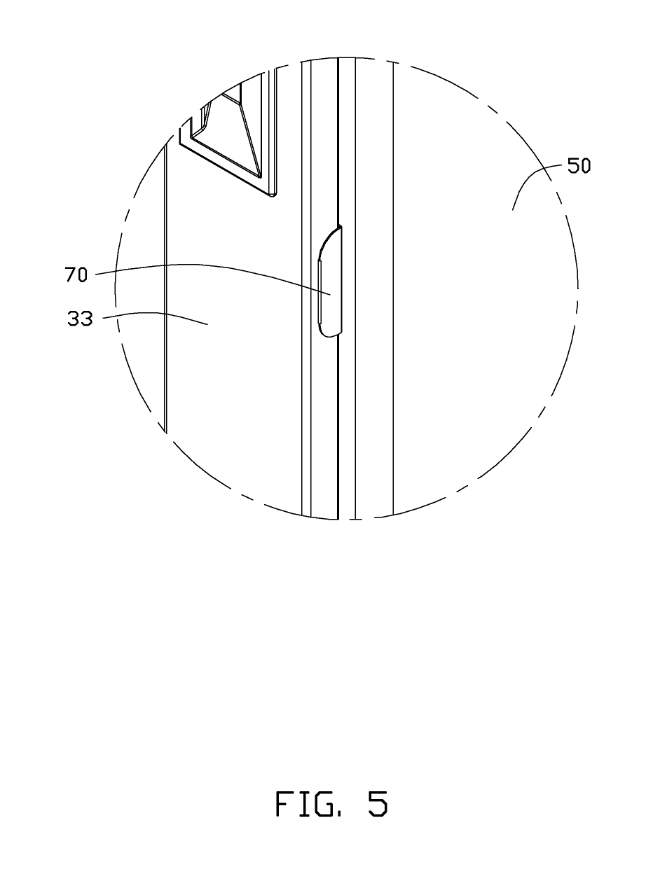

FIGS. 4-5 show that in assembly, the thermal insulation door 50 is rotatably secured to the front door 30 by securing the three hinges 351 to the second sidewall 53 and the front door 30. The securing piece 71 is secured to the first sidewall 51 of the thermal insulation door 50 via fasteners. At this position, an acute angle is defined between the first sidewall 51 and the resilient piece 73, and the latching piece 751 is perpendicular to the first sidewall 51. To close the thermal insulation door 50, the actuating piece 77 is pushed by a user to resiliently deform the resilient piece 73 toward the first sidewall 51. The thermal insulation door 50 is rotated along a first direction until the latching piece 751 extends past the blocking portion 331. Then, the actuating piece 77 is released, and the resilient piece 73 resiliently rebounds, so that the latching potion 75 engages with the blocking piece 3313 to prevent the thermal insulation door 50 from rotating relative to the front door 30.

To open the thermal insulation door 50, the actuating piece 77 is pushed so that the latching portion 75 disengages from the blocking piece 3313. The thermal insulation door 50 is rotated along a second direction opposite to the first direction to open the thermal insulation door 50.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a front door;
a thermal insulation door rotatably secured to the front door; and
a latching member secured to the thermal insulation door and engaged with the front door to prevent the thermal insulation door from rotating relative to the front door; and
the latching member is resiliently deformable to be disengaged from the first side plate.

2. The automatic vending machine of claim 1, wherein the latching member comprises a securing piece, and the securing piece is secured to the thermal insulation door.

3. The automatic vending machine of claim 2, wherein the latching member further comprises a resilient piece extending from the securing piece; and an obtuse angle is defined between the securing piece and the resilient piece.

4. The automatic vending machine of claim 3, wherein the front door comprises a first side plate, and a blocking portion extends from the first side plate; the latching member further comprises a latching portion, and the blocking portion is engaged with the latching portion, and the resilient piece is resiliently deformable to be disengaged from the blocking portion.

5. The automatic vending machine of claim 4, wherein the latching portion comprises a latching piece extending from the resilient piece, an acute angle is defined between the resilient piece and the latching piece; and the blocking portion blocks the latching piece.

6. The automatic vending machine of claim 5, wherein the latching portion further comprises a limiting piece, the limiting piece is perpendicular to the latching piece, and the blocking portion abuts the limiting piece.

7. The automatic vending machine of claim 1, wherein the front door includes a front plate, a first side plate, and a second side plate; the first side plate and the second side plate are located on opposite sides of the front plate; the thermal insulation door comprises a first sidewall and a second sidewall opposite to the first sidewall, the second sidewall is secured to the second side plate, and the latching member is adjacent to the first sidewall and engaged with the first side plate.

8. The automatic vending machine of claim 7, wherein a blocking portion extends from the first side plate, and the blocking portion blocks the latching member.

9. The automatic vending machine of claim 8, wherein the blocking portion comprises a resisting piece extending from the first side plate, and a blocking piece extending from the resisting piece; and the blocking pieces is perpendicular to the resisting piece.

10. The automatic vending machine of claim 9, wherein the resisting piece blocks the latching member.

11. An automatic vending machine comprising:
a front door comprising a front plate, a first side plate, and a second side plate; the first side plate and the second side plate being located on opposite sides of the front plate;
a thermal insulation door rotatably secured to the second side plate; and
a latching member secured to the thermal insulation door and engaged with the first side plate to prevent the thermal insulation door from rotating relative to the front door;
and the latching member is resiliently deformable to disengage the latching member from the first side plate.

12. The automatic vending machine of claim 11, wherein the latching member comprises a securing piece, and the securing piece is secured to the thermal insulation door.

13. The automatic vending machine of claim 12, wherein the latching member further comprises a resilient piece extending from the securing piece; and an obtuse angle is defined between the securing piece and the resilient piece.

14. The automatic vending machine of claim 13, wherein the front door comprising a first side plate, and a blocking portion extends from the first side plate; the latching member further comprises a latching portion, and the blocking portion is engaged with the latching portion, and the resilient piece is resiliently deformable to disengage from the latching portion from the blocking portion.

15. The automatic vending machine of claim 14, wherein the latching portion comprises a latching piece extending from the resilient piece, an acute angle is defined between the resilient piece and the latching piece; and the blocking portion blocks the latching piece.

16. The automatic vending machine of claim 15, wherein the latching portion further comprises a limiting piece, the limiting piece is perpendicular to the latching piece, and the blocking portion abuts the limiting piece.

17. The automatic vending machine of claim 11, wherein the thermal insulation door comprises a first sidewall and a second sidewall opposite to the first sidewall; the second sidewall is secured to the second side plate, and the latching member is adjacent to the first sidewall and engaged with the first side plate.

18. The automatic vending machine of claim 17, wherein a blocking portion extends from the first side plate, and the blocking portion blocks the latching member.

19. The automatic vending machine of claim 18, wherein the blocking portion comprises a resisting piece extending from the first side plate, and a blocking piece extending from the resisting piece; the blocking pieces is perpendicular to the resisting piece.

20. The automatic vending machine of claim 19, wherein the resisting piece blocks the latching member.
